(19) United States
(12) Patent Application Publication
(10) Pub. No.: US 2026/0254171 A1
(43) Pub. Date: Aug. 27, 2026

(54) CONNECTOR ASSEMBLY

(71) Applicant: Aptiv Technologies AG, Schaffhausen (CH)

(72) Inventors: Laurent MORIN, Rambouillet (FR); Ramakrishna MANNE, Andhra Pradesh (IN); Pradeep Krishna RANGANATHAN, Perungalathur (IN)

(21) Appl. No.: 19/462,019

(22) Filed: Jan. 28, 2026

(30) Foreign Application Priority Data
Feb. 18, 2025 (EP) 25158693.9

(51) Int. Cl. H01R 13/6592; H01R 13/6585

(52) U.S. Cl. CPC H01R 13/6592; H01R 13/6585

(57) ABSTRACT

A connector assembly includes a first electrical conductor surrounded by a first electromagnetic shield, and a second electrical conductor electrically connected to the first electrical conductor and surrounded by a second electromagnetic shield. The second electromagnetic shield is formed by a rolled sheet of conductive material and includes a cylindrical trunk and elastically deformable lances that are in mechanical and electrical contact with the first electromagnetic shield. The lances have proximal and distal portions, with the distal portions forming an edge of a flared opening and are separated by slots with a width greater than the sheet thickness. The slots have a bend at their distal portions to prevent another electromagnetic shield from becoming stuck, allowing for secure and reliable connection.

### CROSS-REFERENCE TO RELATED APPLICATION

This application claims the benefit of and priority to European Application No. 25158693.9 filed with the European Patent Office on Feb. 18, 2025, the contents of which are incorporated by reference herein.

### TECHNICAL FIELD

The present disclosure generally relates to a connector assembly and an electromagnetic shield for this connector assembly.

### BACKGROUND

Connector assemblies according to the prior art shown in FIG. 1 include the electromagnetic shield 2, which comprises resilient lances 4 separated from each other by slots 6. As shown in FIGS. 2 and 3, another electromagnetic shield 8, identical to the shield 2, can be pushed into a slot 6 of the shield 2. It results in the two shields 2 and 8 being stuck together. In particular, this occurs when a large number of samples of the electromagnetic shield 2 are bulk-packed in a box for dispatch to a recipient. If two electromagnetic shields are stuck together in this way, they may be damaged, particularly during transport.

To avoid this, the electromagnetic shields 2, 8 are not bulk-packed in a box but carefully placed next to each other on a tray with a compartment for each electromagnetic shield. This tray prevents the electromagnetic shields from colliding during transport. In this way, two electromagnetic shields do not become stuck in each other.

However, the use of a tray complicates the packaging of these electromagnetic shields and therefore increases the cost of transporting these electromagnetic shields. Consequently, the cost of manufacturing the connector assembly comprising this electromagnetic shield is increased.

### SUMMARY

In some aspects, the techniques described herein relate to a connector assembly, including a first electrical conductor and a first electromagnetic shield surrounding the first electrical conductor; a second electrical conductor electrically connected to the first electrical conductor; and a second electromagnetic shield surrounding the second electrical conductor, this second electromagnetic shield being formed by a sheet of conductive material rolled around an axis of revolution, in which this second electromagnetic shield includes: a cylindrical trunk whose generatrices are parallel to the axis of revolution between first and second planes perpendicular to the axis of revolution, and elastically deformable lances arranged around the axis of revolution and directly in mechanical and electrical contact with the first electromagnetic shield, each of these lances including: a proximal portion which, starting from the second plane and moving away from the cylindrical trunk, moves continuously away from the axis of revolution, a distal portion which, in combination with the distal portions of other lances, forms an edge of a flared opening centered on the axis of revolution, and slots which separate the lances from one another, a width of these slots being greater than a thickness of the sheet of conductive material and each of these slots including a proximal portion situated between the proximal portions of two contiguous lances and a distal portion situated between the distal portions of these two contiguous lances, this distal portion of the slot opening directly into the edge of the flared opening, wherein the distal portion of each slot includes a bend to prevent another electromagnetic shield made from a sheet of the same thickness from being stuck inside this slot.

In some aspects, the techniques described herein relate to an assembly, wherein the second electrical conductor includes a stripped end of an electrical cable.

In some aspects, the techniques described herein relate to an electromagnetic shield, wherein the electromagnetic shield is formed by a sheet of conductive material rolled around an axis of revolution and the electromagnetic shield includes a cylindrical trunk whose generatrices are parallel to the axis of revolution between first and second planes perpendicular to the axis of revolution, and elastically deformable lances arranged around the axis of revolution and configured to be directly in mechanical and electrical contact with the first electromagnetic shield, each of these lances including: a proximal portion which, starting from the second plane and moving away from the cylindrical trunk, moves continuously away from the axis of revolution, a distal portion which, in combination with the distal portions of other lances, forms an edge of a flared opening centered on the axis of revolution, and slots which separate the lances from one another, a width of these slots being greater than a thickness of the sheet of conductive material and each of these slots including a proximal portion situated between the proximal portions of two contiguous lances and a distal portion situated between the distal portions of these two contiguous lances, this distal portion of the slot opening directly into the edge of the flared opening, wherein the distal portion of each slot includes a bend to prevent another electromagnetic shield made from a sheet of the same thickness from being stuck inside this slot.

In some aspects, the techniques described herein relate to a shield, wherein the distal portion of the slot has a flared section which extends from the bend to the edge of the flared opening, the width of this flared section increasing continuously while moving away from the proximal portion of this slot.

In some aspects, the techniques described herein relate to a shield, wherein at the edge of the flared opening the width of the flared section is greater than 4*es, where es is the thickness of the sheet of conductive material.

In some aspects, the techniques described herein relate to a shield, wherein as it moves in a direction parallel to the axis of revolution and away from the cylindrical trunk, the distal portion of each lance moves continuously closer to the axis of revolution.

In some aspects, the techniques described herein relate to a shield, wherein the proximal portion of each lance is straight.

In some aspects, the techniques described herein relate to a shield, wherein the width of the proximal portion of the slot is between es and 4*es, where es is the thickness of the sheet of conductive material.

In some aspects, the techniques described herein relate to a shield, wherein the bend extends along an upstream straight line and then along a downstream straight line, and an angle between the upstream and downstream straight lines is between 70° and 110°.

In some aspects, the techniques described herein relate to a shield, wherein the bend extends along an upstream straight line and then along a downstream straight line and wherein the bend extends along the downstream straight line over a distance greater than the width of the proximal portion of the slot.

In some aspects, the techniques described herein relate to a shield, wherein a cross-section of the cylindrical trunk is circular.

### BRIEF DESCRIPTION OF THE DRAWINGS

Other features, details, and advantages of the disclosure will become more apparent from the detailed illustrative description given hereafter with respect to the drawings in which:

FIG. 1 is an isometric view of an electromagnetic shield according to the prior art.

FIGS. 2 and 3 are isometric views of two electromagnetic shields stuck together according to the prior art.

FIG. 4 is an isometric view of a connector assembly according to some embodiments.

FIG. 5 is a cross-section view of the connector assembly of FIG. 4 along a longitudinal axis according to some embodiments.

FIG. 6 is an enlarged view of a portion of FIG. 5 according to some embodiments.

FIGS. 7 and 8 are further enlarged views of portions of FIG. 6 according to some embodiments.

FIG. 9 is an isometric view of an electromagnetic shield of the connector assembly of FIG. 4 according to some embodiments.

FIG. 10 is an enlarged view of a portion of FIG. 9 according to some embodiments.

FIGS. 11 and 12 are views illustrating shields prevented from interlocking according to some embodiments

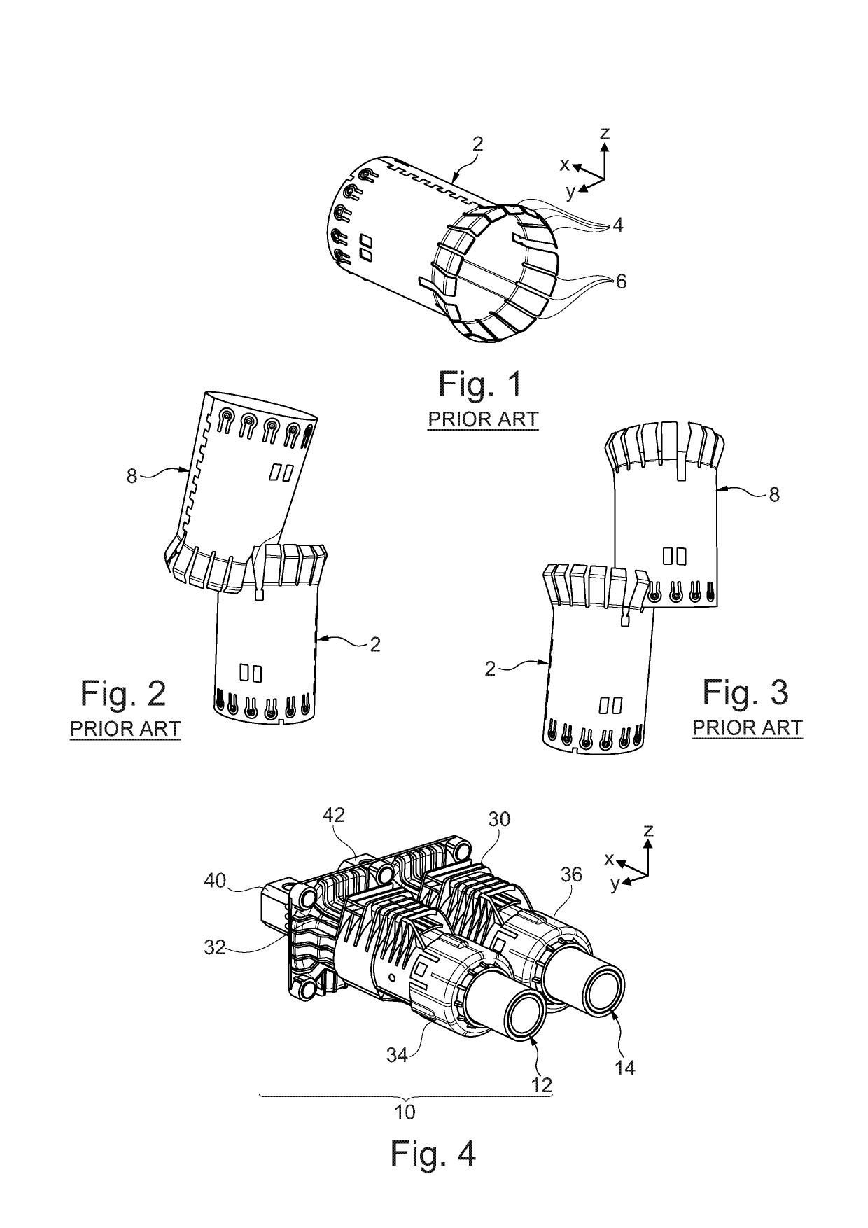

### DETAILED DESCRIPTION

In the figures, the same references are used to designate the same elements.

In the remainder of this description, features and functions well known to the skilled person are not described in detail.

The figures are oriented with respect to an orthogonal reference frame XYZ, where the X and Y directions are horizontal and the Z direction is vertical. The terms "left" and "right" are defined in relation to the X direction.

An electrically conductive material is one whose electrical conductivity at 20° C is greater than 10⁴ S/m or 10⁶ S/m.

An electrically insulating material is one whose electrical conductivity at 20° C is less than 10⁻¹⁰ S/m or 10⁻¹⁴ S/m.

The expression "an element made of material A" or the expression “a material A element" means that material A represents 90% or 95% of the mass of this element.

The "*" symbol indicates scalar multiplication.

A high DC voltage is a DC voltage greater than 100 Vdc or 500 Vdc. Generally, a high DC voltage is a voltage that is smaller than 5000 Vdc or 2000 Vdc.

A high DC current is a DC current greater than 10 A or 20 A. Generally, a high DC current is smaller than 500 A or 100 A.

This disclosure aims to overcome the disadvantages identified in the BACKGROUND section by providing an electromagnetic shield that can be bulk-packed in a box.

FIG. 4 shows a connector assembly 10. Here, connector assembly 10 is a high-voltage connector. Accordingly, connector assembly 10 is designed to support, without any damage, a high DC current and a high DC voltage. For example, connector assembly 10 is intended to electrically connect a battery pack of an electric vehicle to a DC/DC converter or to an onboard charger (OBC). An onboard charger (OBC) is a power electronics device in electric vehicles that converts AC power from external sources, such as residential outlets, to DC power to charge the vehicle's battery pack.

In this example, assembly 10 is fixed, without any degree of freedom, to the end of two identical electrical cables 12 and 14.

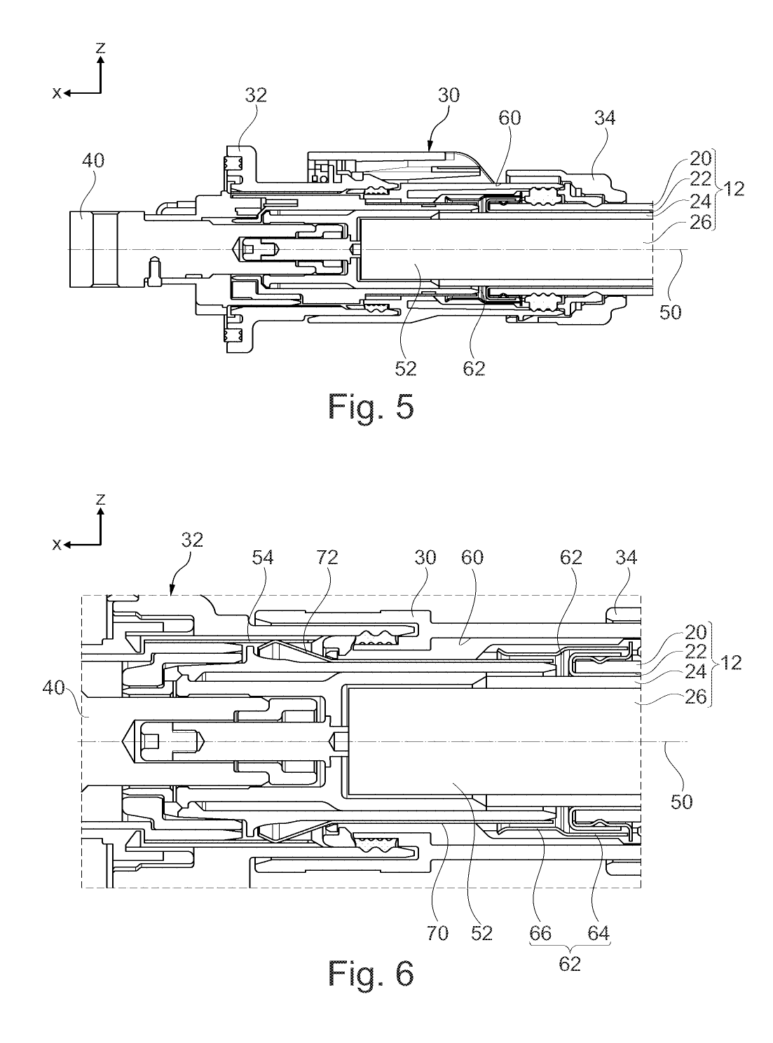

Cable 12 comprises, from the exterior to the interior of the cable, an outer insulative sheath 20 (FIG. 5, 6), a braid 22 (FIG. 5, 6), an inner insulative sheath 24 (FIG. 5, 6) and an electrical conductor 26 (FIG. 5, 6). The insulative sheaths 20 and 24 are made of an electrically insulating material. Braid 22 and conductor 26 are made of an electrically conductive material. Braid 22 forms, in use, an electromagnetic shield. Conductor 26 is, for example, made of copper.

Connector assembly 10 comprises an outer casing 30 inside which the stripped ends of the cables 12, 14 are housed, an outer housing 32 fitted onto one end of casing 30, retainers 34, 36, each of which retains a respective stripped end of one of the cables 12, 14 inside the casing 30, and connection electrodes 40, 42 projecting from the housing 32. The casing 30 and the housing 32 are made of an electrically non-conductive material such as plastic. The electrodes 40, 42 are electrical conductors, here shaped to facilitate their electrical and mechanical connection to other elements such as another electrical connector.

FIG. 5 shows a longitudinal sectional view of assembly 10 along a vertical plane passing through cable 12 and electrode 40. FIG. 6 is an enlarged partial view of FIG. 5. Inside the casing 30, the end of the conductor 26 extends along an axis 50 of revolution. Here, axis 50 is parallel to direction X. In FIGS. 5 and 6, casing 30 receives one stripped end 52 of the cable 12.

The housing 32 receives and surrounds one end of the electrode 40. To limit the electromagnetic radiation from the electrode 40, the housing 32 comprises an electromagnetic shield 54 (FIG. 6) which completely surrounds the end of the electrode 40 received inside the housing 32. For example, the shield 54 is formed by a cylinder of conductive material centered on the axis 50.

The casing 30 comprises a cylindrical channel 60 (FIG. 5, 6) of circular cross-section and centered on the axis 50, inside which the stripped end 52 is received.

A ferrule 62 (FIG. 6) is received inside the channel 60. This ferrule 62 completely surrounds the end of the cable 12 received inside the housing 32. The ferrule 62 is directly mechanically and electrically connected to the braid 22 of this cable 12. Here, the ferrule 62 comprises two tubular sections 64, 66 (FIG. 6). The tubular section 64 covers the insulative sheath 20 and comes into direct electrical and mechanical contact with the braid 22. The other tubular section 66 completely surrounds a portion of the end of the cable 12 where the sheath 20 and the braid 22 have been removed, while leaving the inner insulative sheath 24. The ferrule 62 is made of electrically conductive material.

The casing 30 also includes an electromagnetic shield 70 (FIG. 6) which completely surrounds the stripped end 52 and ensures electrical continuity between the braid 22 and the shield 54. To achieve this, the shield 70 is in direct mechanical and electrical contact, on one side, with the ferrule 62 and, on the opposite side, with the shield 54. The shield 70 is centered on the axis 50 and extends along the axis 50 from the ferrule 62 to the shield 54.

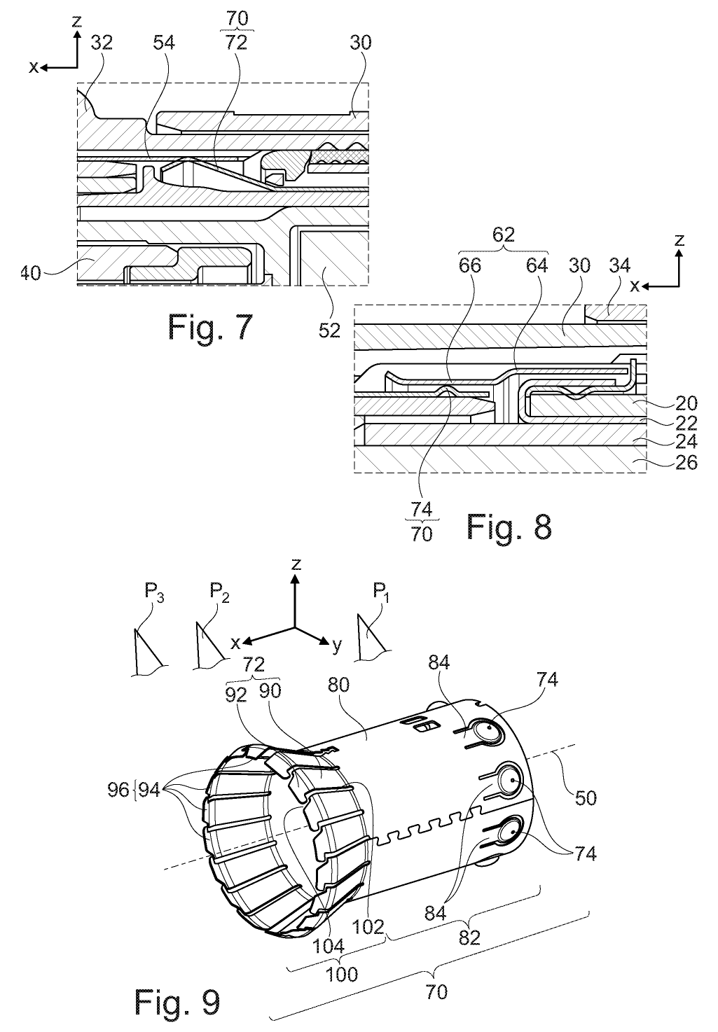

As shown in FIG. 7, to ensure good electrical contact with the shield 54, the left end of the shield 70 has resilient lances 72 which are permanently pressed against the shield 54. Lances 72 are elastically deformable blades or lamellae.

As can be seen in FIG. 8, to ensure good electrical contact with section 66 of the ferrule 62, the right-hand end of the shield 70 has bumps 74 which are permanently urged against section 66.

FIG. 9 shows the shield 70 in more detail. The shield 70 is formed by a single sheet 80 of electrically conductive material rolled around the axis 50. Typically, the sheet 80 is made of metal. The thickness eₛ of the sheet 80 is typically between 0.2 mm and 0.5 mm. Here, the thickness eₛ is equal to 0.3 mm.

The shield 70 comprises a cylindrical trunk 82 whose generatrices are parallel to the axis 50. This trunk 82 extends from a plane P₁ to a plane P₂. The planes P₁ and P₂ are both perpendicular to the axis 50. Here, the cross-section of the trunk 82 is circular. Resilient blades 84 are cut into the right end of the trunk 82. Each of the bumps 74 is arranged on a free end of a respective blade 84.

The lances 72 extend to the left from plane P₂. The lances 72 are distributed around the axis 50. Typically, the number of lances 72 is greater than five, ten or twenty. For example, here the number of lances 72 is eighteen. The number of lances 72 is generally less than fifty or one hundred. In this embodiment, the lances 72 are identical or very similarly shaped. In practice, the lances 72 differ from one another mainly in their angular position around the axis 50. In the following part of the text, therefore, only one lance 72 is described in detail.

The lance 72 has a proximal portion 90 which is extended by a distal portion 92. Proximal portion 90 is directly connected to the left end of trunk 82 at plane P₂. Here, the proximal portion 90 moves continuously away from the axis 50 as it moves in the X direction. To this end, the proximal portion 90 is connected to the trunk 82 by means of a fold, the folding line of which is contained in the plane P₂. Preferably, the proximal portion 90 is straight and flat. The length L₉₀ of the proximal portion 90 is typically greater than 4 mm or 6 mm and generally less than 20 mm or 10 mm. The width of each proximal portion 90 is typically greater than 2 mm or 3 mm and less than 10 mm or 5 mm. The angle between the plane that entirely contains the proximal portion 90 and the axis 50 is, for example, greater than 5° or 10° and less than 45° or 30°.

The distal portion 92 forms, in combination with the distal portions of the other lances 72, the edge 94 (FIG. 9, 10) of a flared opening 96 (FIG. 9) centered on the axis 50 and located at the left end of the shield 70. The distal portion 92 continuously approaches the axis 50 while moving in the X direction. To this end, the distal portion 92 is separated from the proximal portion 90 by a fold, the folding line of which is contained in a plane P₃ (FIG. 9, 10) parallel to the plane P₂ and located to the left of the plane P₂. Typically, the distal portion 92 is flat. The length L₉₂ of the distal portion 92 is smaller than the length of the proximal portion 90. Typically, the length L₉₂ is smaller than L₉₀/2 or L₉₀/3. Usually, the length L₉₂ is also greater than L₉₀/10.

Slots 100 separate the lances 72 from each other. The slots 100 are identical or very similar to each other. In the following part of the text, therefore, only one slot 100 is described in detail.

The slot 100 has a proximal portion 102 (FIG. 9, 10) and a distal portion 104 (FIG. 9, 10).

The proximal portion 102 is located between the proximal portions 90 of the two adjacent lances 72. Proximal portion 102 extends from plane P₂ to plane P₃. Since the proximal portions 90 are straight, the proximal portion 102 is also straight. The width w₁₀₂ of the proximal portion 102 is greater than the thickness eₛ and, typically, greater than 2*eₛ. Here, the width w₁₀₂ is also less than 8*eₛ or 4*eₛ.

The distal portion 104 is located between the distal portions 92 of two adjacent lances 72. The distal portion 104 opens directly into the edge 94 of the flared opening 96.

The distal portion 104 comprises a bend 106 which prevents the sheet of metal of another electromagnetic shield 70 from sinking inside the slot 100 until the proximal portion 102.

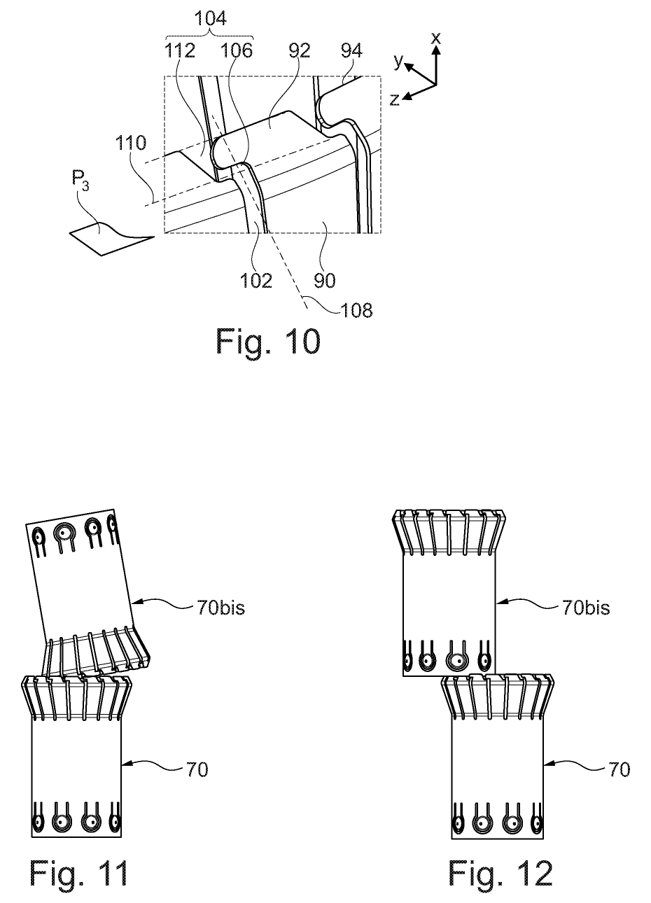

The bend 106 extends along an upstream straight line 108 (FIG. 10) and then along a downstream straight line 110 (FIG. 10). Typically, the angle between the straight lines 108, 110 is between 70° and 110°. For example, here, this angle is between 85° and 95°.

The bend 106 extends along the straight line 110 for a distance d₁₀₆ greater than the width w₁₀₂ of the proximal portion 102. Typically, the distance d₁₀₆ is greater than 1.2*w₁₀₂ or 1.5*w₁₀₂. The distance d₁₀₆ is also generally less than 4*w₁₀₂ or 3*w₁₀₂.

In this embodiment, the distal portion 104 of the slot 100 also includes a flared section 112 (FIG. 10) which extends from the bend 106 to the edge 94 of the flared opening 96. The width of this flared section 112 increases continuously while moving away from the proximal portion 102. Here, the width of the flared section 112 increases continuously as it moves parallel to the upstream straight line 108 and away from the proximal portion 102.

Closest to the bend 106, the width of the flared section 112 is greater than the thickness eₛ and, for example, equal to the width w₁₀₂. At the edge 94 of the flared opening 96, the width of the flared section 112 is greater than 4*eₛ or 8*eₛ.

As shown in FIGS. 11 and 12, the bend 106 prevents another electromagnetic shield, identical to shield 70, from entering into one of the slots 100 till its proximal portion 102. In FIGS. 11 and 12, the other electromagnetic shield is numbered 70bis.

Typically, shield 70 is made from a flat sheet of metal. The individual lances 72 are then cut into this flat sheet, for example by stamping. Once the lances 72 have been cut, the lances 72 are folded to form the fold that connects the proximal portion 90 of each lance to the left end of the trunk 82 and the fold between the proximal and distal portions 90, 92 of each lance. The metal sheet is then rolled around the axis 50 and the longitudinal edges of the sheet are welded together to form the shield 70.

The lances 72 may or may not be arranged at regular intervals around the axis 50.

In another embodiment, the lances 72 are not all identical to each other. For example, some lances are wider than others.

In another embodiment, the distal portion 92 of the lances 72 does not approach the axis 50 as it moves away from the plane P₃. For example, the distal portion 92 moves away from the axis 50 in a direction collinear with the direction followed by the proximal portion 90 of the same lance. In this case, the proximal and distal portions 90, 92 extend in the same plane.

In another embodiment, between the straight proximal portion 90 of the lance 72 and the distal portion 92 of this lance 72, there is an intermediate portion. For example, this intermediate portion extends in a plane parallel to the axis 50. In such a case, the lance 72 comprises two distinct folds, a first fold which separates the proximal portion 90 from the intermediate portion and a second fold which separates the intermediate portion from the distal portion 92.

The bend 106 is not necessarily located halfway along the distal portion 92. For example, alternatively, the bend 106 is located closer to the fold that separates the proximal and distal portions 90, 92. For example, the downstream straight line 110 can be overlaid with the folding line which separates the proximal and distal portions 90, 92. The bend 106 can also be closer to the edge 94 of the flare opening 96.

In another embodiment, the flared section 112 is omitted. Typically, in this case, the distal portion 92 of the slot 100 located after the bend 106 is straight.

Alternatively, the cross-section of the cylindrical trunk 82 is non-circular. For example, the cross-section of the cylindrical trunk can be square or rectangular.

Several of the embodiments described above can be combined in a single embodiment.

The presence of the bend 106 in the distal portion 104 of each slot 100 prevents the metal sheet of another identical electromagnetic shield from being stuck into one of the slots 100. Consequently, the electromagnetic shields 70 can be transported in bulk packages without the risk of them being damaged. In particular, it is no longer necessary to arrange them next to each other on a tray to transport them without the risk of damage. This reduces the cost of transporting these electromagnetic shields.

The flared section 112 further reduces the risk of damaging an electromagnetic shield during transportation in bulk packages. In fact, even if the metal sheet of a first electromagnetic shield enter the flared section 112 of a second electromagnetic shield, they can be separated without any damage because the flared section 112 is flared.

When the width of the flared section 112 is greater than 4*eₛ, this allows the first electromagnetic shield to be separated from the second electromagnetic shield simply by moving the first electromagnetic shield without having to handle the second electromagnetic shield.

The fact that the distal portions 92 are folded towards the axis 50 limits the friction of the lances 72 on the electromagnetic shield 54 when shield 70 is fitted inside the shield 54.

The fact that the proximal portion 90 of each lance 72 is straight simplifies the manufacturing process of the electromagnetic shield 70.

The fact that the width w₁₀₂ of the proximal portions 102 of the slot 100 is between eₛ and 4*eₛ reduces the loss of material during the manufacturing process.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A connector assembly, comprising:
a first electrical conductor and a first electromagnetic shield surrounding the first electrical conductor;
a second electrical conductor electrically connected to the first electrical conductor; and
a second electromagnetic shield surrounding the second electrical conductor, this second electromagnetic shield being formed by a sheet of conductive material rolled around an axis of revolution, in which this second electromagnetic shield comprises:
a cylindrical trunk whose generatrices are parallel to the axis of revolution between first and second planes perpendicular to the axis of revolution, and
elastically deformable lances arranged around the axis of revolution and directly in mechanical and electrical contact with the first electromagnetic shield, each of these lances comprising:
a proximal portion which, starting from the second plane and moving away from the cylindrical trunk, moves continuously away from the axis of revolution,
a distal portion which, in combination with the distal portions of other lances, forms an edge of a flared opening centered on the axis of revolution, and
slots which separate the lances from one another, a width of these slots being greater than a thickness of the sheet of conductive material and each of these slots comprising a proximal portion situated between the proximal portions of two contiguous lances and a distal portion situated between the distal portions of these two contiguous lances, this distal portion of the slot opening directly into the edge of the flared opening, wherein the distal portion of each slot comprises a bend to prevent another electromagnetic shield made from a sheet of the same thickness from being stuck inside this slot.

2. The assembly of claim 1, wherein the second electrical conductor comprises a stripped end of an electrical cable.

3. An electromagnetic shield formed from a sheet of conductive material rolled around an axis of revolution, the electromagnetic shield comprising:
a cylindrical trunk whose generatrices are parallel to the axis of revolution between first and second planes perpendicular to the axis of revolution, and
elastically deformable lances arranged around the axis of revolution and configured to be directly in mechanical and electrical contact with the electromagnetic shield, each of these lances comprising:
a proximal portion which, starting from the second plane and moving away from the cylindrical trunk, moves continuously away from the axis of revolution,
a distal portion which, in combination with the distal portions of other lances, forms an edge of a flared opening centered on the axis of revolution, and
slots which separate the lances from one another, a width of these slots being greater than a thickness of the sheet of conductive material and each of these slots comprising a proximal portion situated between the proximal portions of two contiguous lances and a distal portion situated between the distal portions of these two contiguous lances, this distal portion of the slot opening directly into the edge of the flared opening, wherein the distal portion of each slot comprises a bend to prevent another electromagnetic shield made from a sheet of the same thickness from being stuck inside this slot.

4. The shield according to claim 3, wherein the distal portion of the slot has a flared section which extends from the bend to the edge of the flared opening, the width of this flared section increasing continuously while moving away from the proximal portion of this slot.

5. The shield according to claim 4, wherein at the edge of the flared opening the width of the flared section is greater than 4*eₛ where eₛ is the thickness of the sheet of conductive material.

6. The shield according to claim 3, wherein as it moves in a direction parallel to the axis of revolution and away from the cylindrical trunk, the distal portion of each lance moves continuously closer to the axis of revolution.

7. The shield according to claim 3, wherein the proximal portion of each lance is straight.

8. The shield according to claim 3, wherein the width of the proximal portion of the slot is between eₛ and 4*eₛ where eₛ is the thickness of the sheet of conductive material.

9. The shield according to claim 3, wherein the bend extends along an upstream straight line and then along a downstream straight line, and an angle between the upstream and downstream straight lines is between 70° and 110°.

10. The shield according to claim 3, wherein the bend extends along an upstream straight line and then along a downstream straight line and wherein the bend extends along the downstream straight line over a distance greater than the width of the proximal portion of the slot.

11. The shield according to claim 3, wherein a cross-section of the cylindrical trunk is circular.
